(19) United States
(12) Patent Application Publication
(10) Pub. No.: US 2004/0070631 A1
(43) Pub. Date: Apr. 15, 2004

(54) Apparatus and method for viewing thumbnail images corresponding to print pages of a view on a display

(76) Inventors: Mark L. Brown, Boise, ID (US); Vincent Skurdal, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/261,009

(22) Filed: Sep. 30, 2002

(51) Int. Cl. G09G 5/00

(52) U.S. Cl. 345/838

(57) ABSTRACT

The present invention provides a system and method for identifying print pages for printing. Briefly described, one embodiment receives a print command, determines a plurality of print pages associated with a current view on a display, generates a plurality of thumbnail images, each one of the thumbnail images uniquely corresponding to one of the plurality of print pages and such that each one of the thumbnail images represents a reduced view of the corresponding print page, communicates the plurality of thumbnail images to the display, and receives a second print command such that the print pages are communicated to a printing device.

### TECHNICAL FIELD

The present invention is generally related to communicating and printing images and, more particularly, is related to a system and method for identifying print pages for printing.

### BACKGROUND

Image communication devices are configured to receive electronic information corresponding to images such that one or more corresponding print pages are printed on a printing medium. A nonlimiting example of such a device includes a personal computer (PC). For example, a PC may receive a plurality of images corresponding to an e-mail or a web page over the Internet. Images may be images of objects and/or textual information.

Often, the resources of the device printing the received plurality of images, such as paper, are wasted when undesirable images are printed. For example, separate images may each require a single sheet of paper for printing. Other received images may have large blank regions where no image or text appear on the printed medium.

Furthermore, as when printing web pages via a browser or other viewing program, pagination markers, page breaks and/or page markers may not be visible on the displayed page. Thus, what appears to be a reasonable number of pages for printing based upon the displayed image (web page, e-mail or the like) may actually turn out to have many undesirable printed pages since hidden page breaks, which cause the printing device to begin printing on a new sheet of paper, are not detectable before the displayed image is printed.

Also, displayed images (web pages, e-mails and the like) may include headers, footers and/or trailing information that is of no interest to the individual printing the displayed image. For example, an e-mail may include a large section of routing information at the end of the e-mail. Also, if the e-mail is forwarded from another person (and includes an original message), the original message may be included. Furthermore, the more times an e-mail is forwarded, the longer the trailing section of routing information at the end of the e-mail becomes. All of this information may be undesirable. Thus, paper is wasted when this information is printed.

Furthermore, web pages may include banners and/or other types of advertisement. When the web page is printed, such banners and advertisements are printed. If such banners and advertisements are undesirable, paper is wasted. Alternatively, the user may desire only a printed copy of the banner or other advertising, and not the remainder of the web page. Thus, when the web page is printed, the printing device prints the entire undesirable web page in addition to the desirable banner or advertisement.

### SUMMARY

The present invention provides a system and method for identifying print pages for printing. Briefly described, one embodiment receives a print, command, determines a plurality of print pages associated with a current view on a display, generates a plurality of thumbnail images, each one of the thumbnail images uniquely corresponding to one of the plurality of print pages and such that each one of the thumbnail images represents a reduced view of the corresponding print page, communicates the plurality of thumbnail images to the display, and receives a second print command such that the print pages are communicated to a printing device.

### BRIEF DESCRIPTION OF THE DRAWINGS

The components in the drawings are not necessarily to scale relative to each other. Like reference numerals designate corresponding parts throughout the several views.

FIG. 1 is a diagram illustrating a personal computer employing an embodiment of the present invention.

FIG. 2 is an illustration of a view on a monitor showing an exemplary view of a web page or the like.

FIG. 3 is an illustration of a view on a monitor showing the exemplary view of FIG. 2 processed by the present invention to show a plurality of the thumbnail images corresponding to print pages of a print file.

FIG. 4 is an illustration of a view on a monitor showing thumbnail images corresponding to the pages to be printed after selected thumbnail images have been deselected by an embodiment of the present invention.

FIG. 5 is an illustration of another view on a monitor showing the temporary enlargement of a selected thumbnail image by an embodiment of the present invention.

FIG. 6 is an illustration of a view on a monitor showing the enlargement of the thumbnail images to be printed after selected images have been deselected by an embodiment of the present invention.

FIG. 7 is a flowchart of a process for viewing print pages of a view using an embodiment of the present invention.

FIG. 8 is a flowchart of a process for selecting print pages from a view using an embodiment of the present invention.

### DETAILED DESCRIPTION

The present invention provides a system and method for identifying print pages for printing. Accordingly, embodiments of the present invention conserve resources in a printing device when a plurality of identified print pages are printed. More specifically, resources are conserved by the present invention when undesirable print pages are deselected (or when desirable print pages are selected) prior to printing.

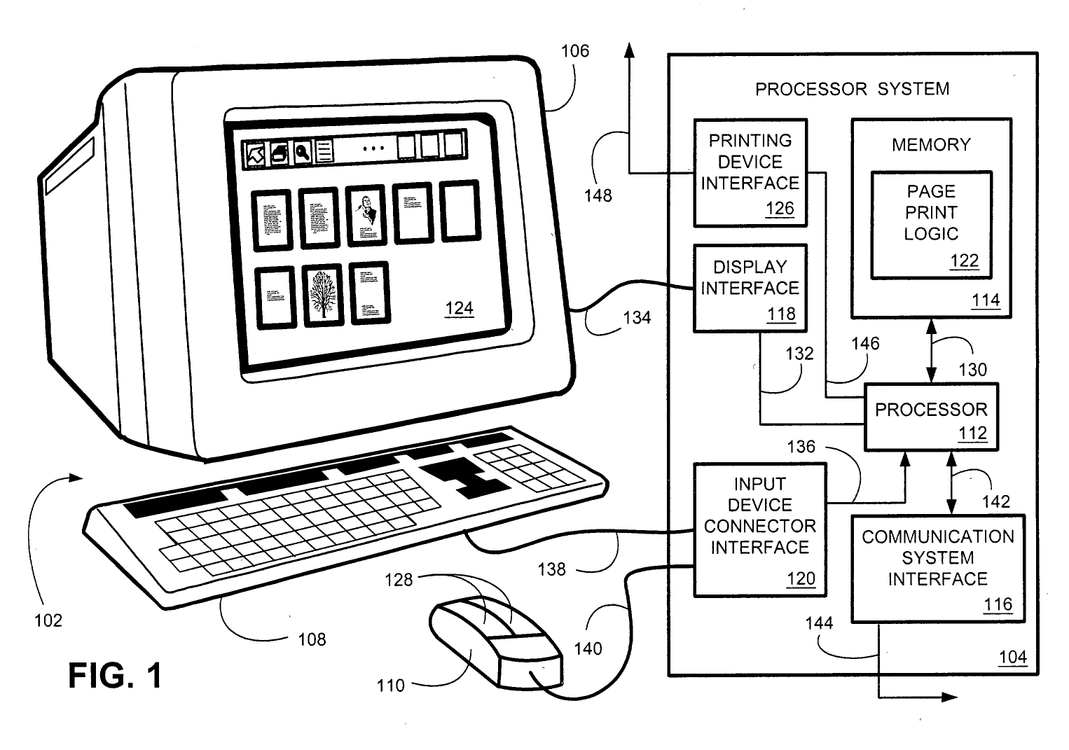

FIG. 1 is a diagram illustrating a personal computer (PC) system 102 employing an embodiment of the present invention. The PC system 102 includes processor system 104, monitor 106, keyboard 108 and mouse device 110. Processor system 104 further includes processor 112, memory 114, communication system interface 116, display interface 118 and input device interface 120. Page print logic 122, residing in memory 114, is retrieved and executed by processor 112. Thumbnail images, generated in accordance with the present invention, are displayed on display 124. A printing device interface 126 is configured to communicate print pages to a printing device (not shown) for printing.

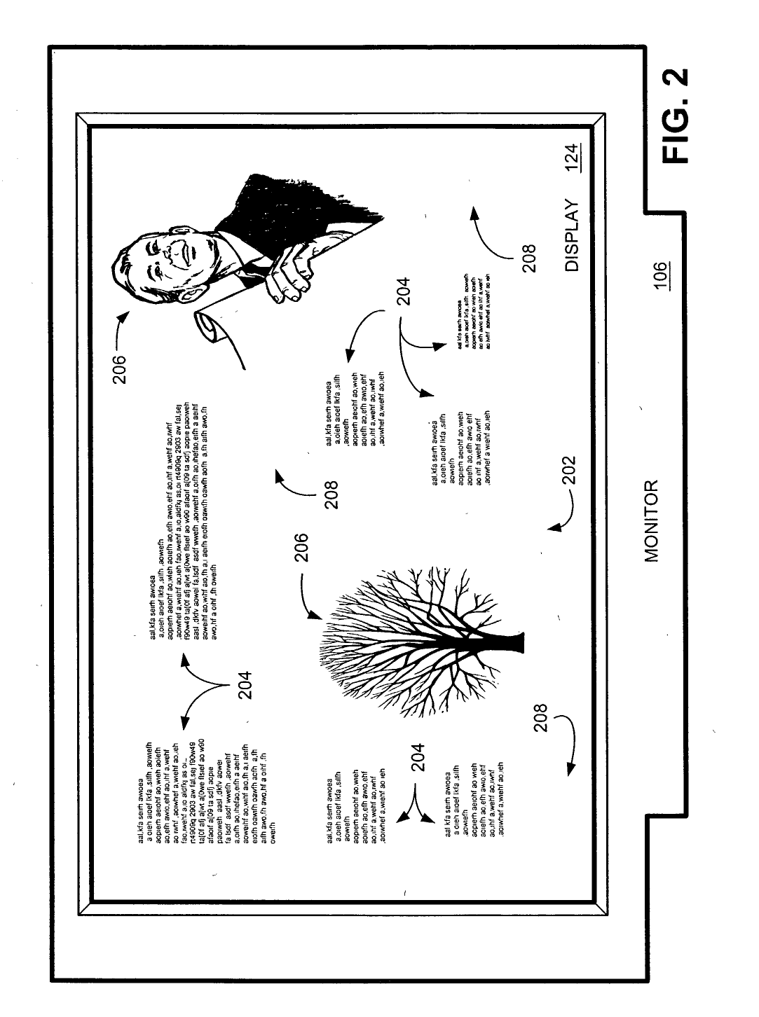

FIG. 2 is an illustration of a view 202 on a monitor showing exemplary view 202 of a web page or the like. Thus, view 202 includes a plurality of textual portions 204, a plurality of images 206, and a plurality of background regions 208 that may be colored and/or patterned. Assuming that the user wants to print view 202, or portions of interest thereon, the user is unable to understand the layout of textual portions 204 and images 206 on pages of printed paper because print pages are not demarked on view 202. Nor can the user know the number of pages of paper that will be used when the view 202 is printed. Furthermore, if a conventional printing engine is used to print view 202, the user may have no control, or at best, partial control of the printing of view 202.

View 202 may correspond to a plurality of print pages generated by any other type of application that generates print pages. For example, the view 202 may be generated by a word processing program or another document processing application. Accordingly, embodiments are configured to identify print pages for printing by selection (and/or deselection) of corresponding thumbnail images where the print pages are generated from any source in accordance with the present invention.

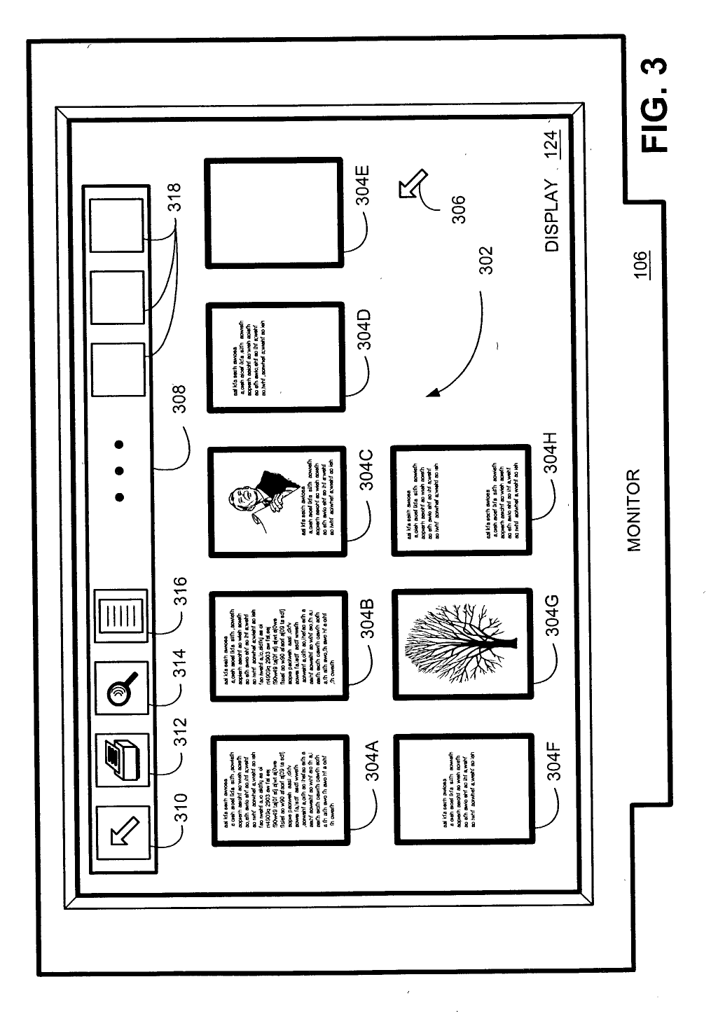

FIG. 3 is an illustration of a view 302 on monitor 106 showing the exemplary view 202 of FIG. 2 processed by the present invention to show an illustrative plurality of thumbnail images 304A-H. Each one of the thumbnail images corresponds to a print page of a print file associated with view 302. Also, each one of the thumbnail images 304A-H is a representative image of its corresponding print page. That is, when the view 302 is processed by the present invention, the user previews the print pages of the current view on display 124 by viewing the thumbnail images 304A-H.

Each one of the thumbnail images 304A-H corresponds to one printed page when the view 302 is printed by a printing device. Thus, in the exemplary view 202 (FIG. 2), the present invention indicates to the user that eight pages of paper will be used when the view 302 is printed (in the absence of further processing by the present invention, as described in greater detail below).

The present invention is activated by the user when the user provides an initial print command to processor system 104 (FIG. 1). Such an initial print command can be generated using any number of processes, such as, but not limited to, selection of a print command via a menu system, actuation of a tool button corresponding to a print command, or the like. Once the initial print command is received by the processor system 104, processor 112 (FIG. 1) retrieves and executes the page print logic 122 such that thumbnail images corresponding to print pages associated with the current view are displayed on display 124.

Because the present invention displays thumbnail images 304A-H corresponding to print pages associated with the current view 302, the user now understands the nature of the printed pages that will be printed when view 302 is sent to a printing device for printing. However, the user may wish to print only selected print pages of view 302. The user, using various embodiments of the present invention, is able to select print pages of interest for printing by selecting corresponding thumbnail images. Or, depending upon the embodiment, the user may choose not to print undesirable print pages by identifying corresponding thumbnail images.

One embodiment displays the thumbnail images 304A-H (FIG. 3) and indicates, in a suitable manner, that each one of the thumbnail images 304A-H will not be printed unless otherwise selected by the user. A pointer icon 306, such as a cursor, arrow or other suitable symbol, is used by the user to select thumbnail images 304A-H. With an embodiment where the user selects print pages for printing by selecting corresponding thumbnail images, the user positions pointer icon 306 onto (or adjacent to, depending upon the embodiment) a thumbnail image and selects the thumbnail image. The selected thumbnail image corresponds to a print page that is to be printed. Print pages associated with the selected thumbnail images are printed when the user generates a print command as described herein.

For example, thumbnail image 304A corresponds to a sheet of paper that the user wants to print. Thus, the user selects thumbnail image 304A by moving pointer icon 306 to the thumbnail image 304A. In one embodiment, the user uses mouse device 110 (FIG. 1) or another suitable device configured to move pointer icon 306 over the display 124, to position pointer icon 306 in close proximity to or over the thumbnail image 304A. When the pointing device is actuated (thereby generating a selection signal), such as when the mouse button 128 (FIG. 1) is clicked, the present invention designates the corresponding print page as a page for printing. Upon selecting the thumbnail image 304A, the thumbnail image 304A is highlighted or otherwise indicates thumbnail image 304A as being selected in view 302, thereby indicating to the user that the print page corresponding to thumbnail image 304A will be printed.

The saving of paper is significantly increased by the present invention when the user is only interested in printing one selected print page. For example, the user may want to print a print page corresponding to thumbnail image 304A. For example, by selecting thumbnail image 304A as described above, only the single print page corresponding to thumbnail image 304A is printed. Thus, seven sheets of paper would be saved.

Another embodiment displays the thumbnail images 304A-H (FIG. 3) and indicates, in a suitable manner, that each one of the thumbnail images 304A-H will be printed unless otherwise selected by the user. Similarly to the above-described embodiment, the pointer icon 306, such as a cursor, arrow or other suitable symbol, is used by the user to deselect thumbnail images that will not be printed. Print pages associated with the thumbnail images not deselected are printed when the user generates a print command as described herein.

Another embodiment includes a “select all” and/or a “deselect all” feature. For example, in the embodiment that initially indicates that all print pages corresponding to thumbnail images are to be printed, the user may implement the “deselect all” feature and then select the print pages to be printed by selecting corresponding thumbnail images. Similarly, the embodiment that initially indicates that all print pages will not be printed, the user may implement the “select all” feature and then deselect the print pages not to be printed by deselecting corresponding thumbnail images. The “select all” and “deselect all” features are implemented by defining function keys on a keyboard or button pad. For example, if a keyboard on a lap top or personal computer is used, “CTRL+S” could be predefined to be the “select all” function (simultaneously actuate the “ctrl” button and the “S” character button). “CTRL+D” could be likewise predefined to be the “deselect all” function. However, any combination of one or more preselected keys could be employed to implement the “select all” and/or a “deselect all” features.

Embodiments of the invention indicate which thumbnail images have been selected and/or deselected by the user. For example, but not limited to, thumbnail images 304A-H may each be indicated by highlighting with shading and/or be indicated by a border or the like. A color may also be used to further indicate a thumbnail image. Or, the thumbnail images 304A-H may be indicated in any manner so long as the user understands that the print pages corresponding to the thumbnail images 304A-H will not be printed, or will be printed, depending upon the embodiment of the present invention.

The above-described indications may be used to indicate either selected thumbnail images or deselected thumbnail images. Or, indications may be used for all thumbnail images, with differing indications identifying selected thumbnail images from deselected thumbnail images.

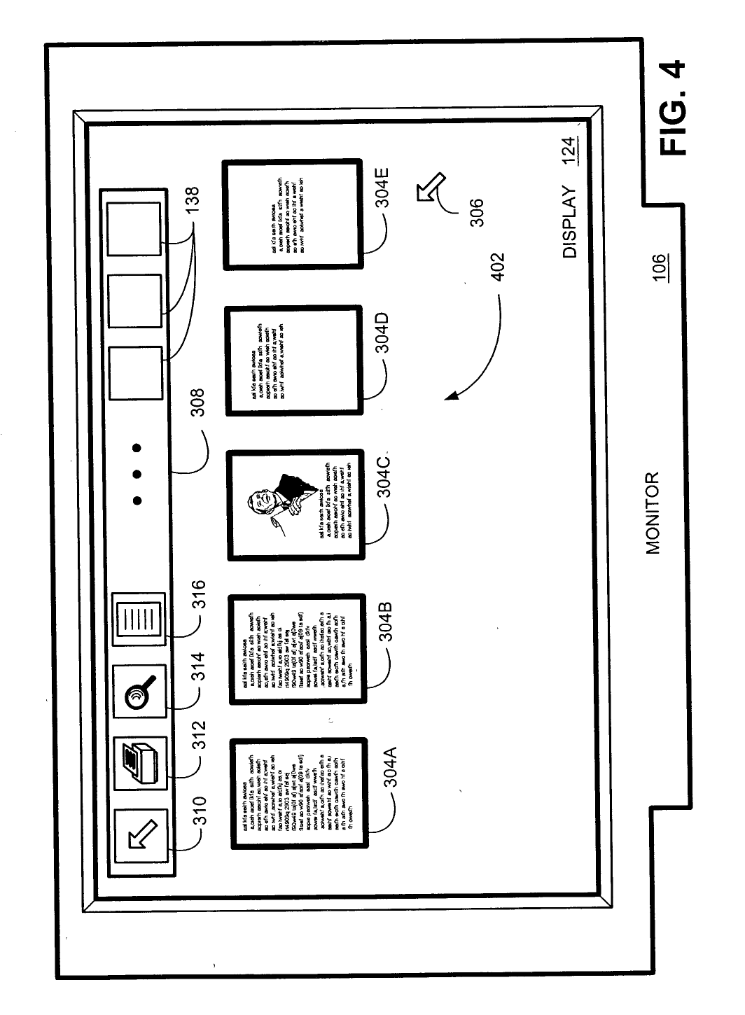

FIG. 4 is an illustration of a view 402 on monitor 106 showing thumbnail images corresponding to the print pages to be printed after selected thumbnail images have been selected by an embodiment of the present invention. That is, selected embodiments of the present invention generate and display a verify view, such as view 402, prior to printing so that the user may verify which print pages will be printing. The user verifies which pages will be printed by viewing corresponding thumbnail images.

FIG. 4 is an illustrative example wherein the user has employed an embodiment of the present invention to select thumbnail images 304A-D and 304F. When the user has completed selection thumbnail images of interest, a command is generated such that view 402 is displayed. Accordingly, in the above-described illustrative example, thumbnail images 304A-D and 304F are displayed on view 402. That is, the user understands that when the print command is issued, print pages corresponding to thumbnail images 304A-D and 304F will be printed, and that print pages corresponding to thumbnail images 304E and 304G-H (FIG. 3) will not be printed. Thus, not printing print pages associated with thumbnail images 304E and 304G-H saves three sheets of paper.

An alternative embodiment of the invention displays the thumbnail images 304A-H (FIG. 3) and indicates, in a suitable manner, that each one of the thumbnail images 304A-H will be printed unless otherwise deselected by the user. For example, but not limited to, thumbnail images 304A-H may each be highlighted with shading, a border or the like. A color may also be used to further indicate thumbnail images that will be printed unless otherwise selected by the user. Alternatively, images that are deselected may be indicated in a suitable manner.

For example, thumbnail image 304E corresponds to a blank sheet of paper. Thus, the user may choose to deselect thumbnail image 304E by moving pointer icon 306 to the thumbnail image 304E. In one embodiment, the user uses mouse device 110 (FIG. 1) or another suitable device configured to move pointer icon 306 over the display 124, to position pointer icon 306 in close proximity to or over the thumbnail image 304E. Then, the user uses one of the mouse buttons 128 (FIG. 1) to deselect the thumbnail image 304E (by actuating the mouse device 110, thereby generating a thumbnail image selection signal that is communicated to the processor system 104). In another embodiment, upon deselecting the thumbnail image 304E, the thumbnail image 304E is removed from view 302 (FIG. 3), thereby indicating to the user that the print page corresponding to thumbnail image 304E will not be printed.

In another embodiment, after print pages have been selected for printing by selecting corresponding thumbnail images, a verify view is shown to the user so that the user can understand which print pages will be printed. With reference to the simplified example of FIG. 4, the user has selected for printing print pages associated with thumbnail images 304A-D and 304F by using embodiments of the present invention. Accordingly, a verify view 402 showing selected thumbnail images 304A-D and 304F corresponding to print pages is displayed on display 124. That is, the user understands that print pages corresponding to thumbnail images 304A-D and 304F will be printed when the user issues the print command. Furthermore, the user understands that print pages corresponding to thumbnail images 304A-D and 304F will not be printed.

The embodiment of the present invention generating the exemplary view 402 is illustrated for convenience as having repositioned thumbnail image 304F after thumbnail image 304E was deleted. Thus, this embodiment displays the print pages that remain for printing after selected thumbnail images are deselected. Remaining thumbnail images are shown in consecutive order by repositioning remaining thumbnail images (and by deleting deselected thumbnail images).

Another embodiment is configured to continue display of deselected thumbnail images. Thus, deselected thumbnail images remain (with an identification means to denote that the thumbnail image has been deselected) on the view so that the user may review and reconsider choice of print pages that will be printed. For example, the user may deselect a thumbnail image intending to not print the print page corresponding to the deselected thumbnail image. However, at a later time, the user may reconsider, and then reselect that thumbnail image, thereby enabling printing of the corresponding print page. Reselecting a thumbnail image is effected by positioning the pointer icon 306 on (or adjacent to, depending upon the embodiment) the deselected thumbnail and by then actuating the pointing device (thereby generating a reselection signal).

As noted above, embodiments of the present invention have a minimum thumbnail image size. This minimum thumbnail image size is selected such that a thumbnail image is sufficiently large so that the user can meaningfully discern the general content of a corresponding print page. Accordingly, if the number of thumbnail images exceed the maximum number of thumbnail images that can be displayed on a single view, the remaining thumbnail images can be viewed by “paging down” to another view. The transition from one view to another can be performed by using predefined function keys on a key board, by using a pulldown menu with a view change selection, or by using arrow keys, tab keys, page up, page down, or other suitable keys.

In the above-described embodiment that repositions thumbnail images as other thumbnail images are deselected, thumbnail images from another view may be moved up to the current view as space becomes available. Thus, as thumbnail images are deselected and deleted from the display 124, remaining thumbnail images are repositioned on the current view. Accordingly, thumbnail images on the next view (which is not displayed) are moved onto the current view as space becomes available.

In the views of FIGS. 3-6, a toolbar 308 having a plurality of tool buttons 310, 312, 314, 316 and 318 is illustrated. The functionality of any particular tool button may be predefined. Similarly, any suitable icon may be used on a tool button to impart an understanding of the tool button functionality to the user. For example, tool button 310, in one embodiment, is configured to refresh and return the view 302 to an original state. Thus, if the user has deselected one or more thumbnail images (or selected thumbnail images, depending upon the embodiment), and subsequently reconsiders the choices made, the user may position the pointer icon 306 over tool button 310, and by actuating tool button 310, reset the view such that all thumbnail images are displayed in an original state. That is, actuation of the tool button 310 selects all print pages for printing (or deselects all print pages, depending upon the embodiment).

For illustration purposes, tool button 312 is illustrated as having an icon that resembles a printing device. Thus, the user understands that actuating tool button 312 causes the currently selected print pages to be communicated to a printing device for printing. That is, actuating tool button 312 initiates the print command such that print pages selected by the user using embodiments of the present invention are printed. In the simplified example of FIG. 3, actuation of tool button 312 will cause print pages corresponding to thumbnail images 304A-H to be printed. In the simplified example of FIG. 4, actuation of tool button 312 will cause print pages corresponding to thumbnail images 304A-D and 304F to be printed.

For illustration purposes, tool button 314 is illustrated as having an icon that resembles a magnifying glass. Thus, the user understands that actuating tool button 314 causes the selected thumbnail images to be magnified, thereby allowing the user to better understand the content of a corresponding print page. Thus, the user, after selecting a thumbnail image and actuating the tool button 314, views an enlarged thumbnail image. In an alternative embodiment, the user may view an enlarged thumbnail image by positioning pointer icon 304 in close proximity to or over the thumbnail image of interest after actuating tool button 314.

In one embodiment, this magnification feature is enabled/disabled by subsequent actuation of the tool button 314. In another embodiment, the magnification feature is configured to magnify only one thumbnail image. Accordingly, tool button 314 is actuated each time a thumbnail image is enlarged.

For illustration purposes, tool button 316 is illustrated as having an icon that resembles a print page. Thus, the user understands that actuating tool button 316 causes the selected thumbnail images to be magnified to a full print page size, thereby allowing the user to better understand the content of a corresponding print page. Thus, the user, after actuating the tool button 316, may enlarge a thumbnail image to a full print page size by positioning pointer icon 306 in close proximity to or over the thumbnail image of interest. In one embodiment, this full print page size feature is enabled/disabled by subsequent actuation of the tool button 316.

The tool bar 308 and associated tool buttons 310, 312, 314, 316 and 318 are optional. In one embodiment, tool bar 308 and associated tool buttons 310, 312, 314, 316 and 318 are not included. In another embodiment, the tool bar 308 and associated tool buttons 310, 312, 314, 316 and 318 may be toggled on/off by the user. Furthermore, tool buttons 310, 312, 314, 316 and/or 318 may be placed in any order on tool bar 308, and that tool bar 308 may be located in any convenient position on the display 124.

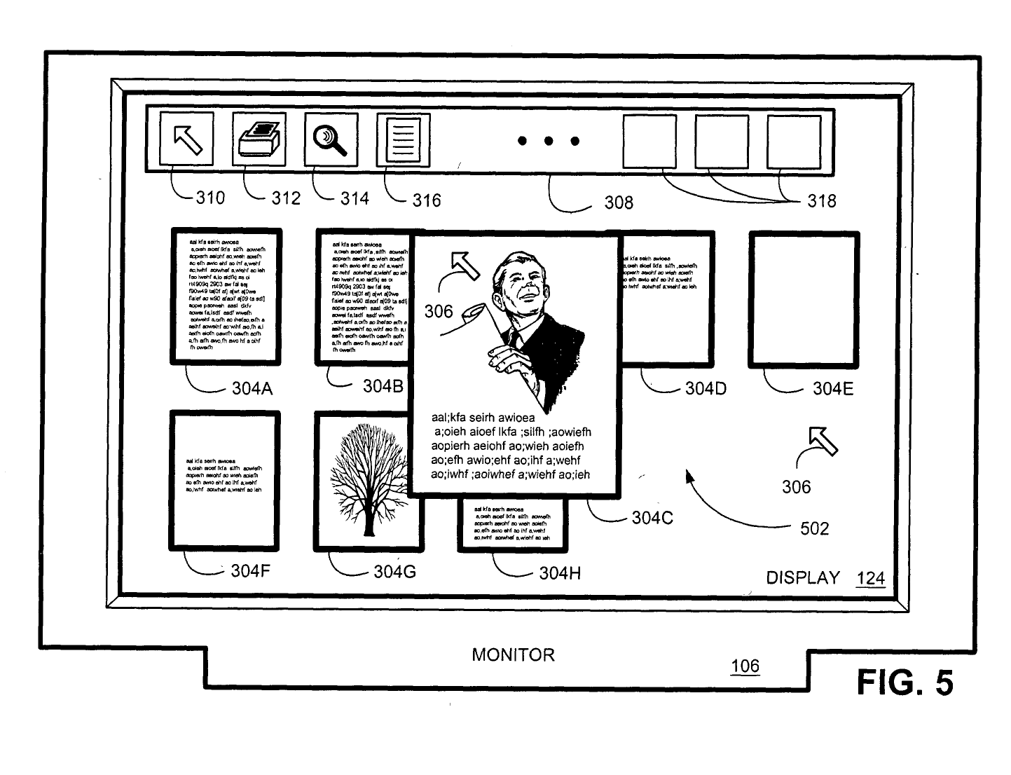

FIG. 5 is an illustration of another view 502 on monitor 106 showing the temporary enlargement of a selected thumbnail image 304C by an embodiment of the present invention. In one embodiment, the resulting illustrative enlargement of thumbnail image 304C results when pointer icon 306 is positioned in close proximity to or over the thumbnail image 304C, as described above in association with the tool button 314. In another embodiment, the magnification is an “always on” feature that is automatically implemented when the pointer icon 306 is held stationary in close proximity to or over the thumbnail image of interest for a predetermined amount of time.

In FIG. 5, the enlarged thumbnail image 304C is illustrated as overlapping adjacent thumbnail images. Thus, parts of adjacent thumbnail images are hidden from view. In another embodiment, adjacent thumbnail images are repositioned on the display 124 so that all thumbnail images are entirely visible to the user.

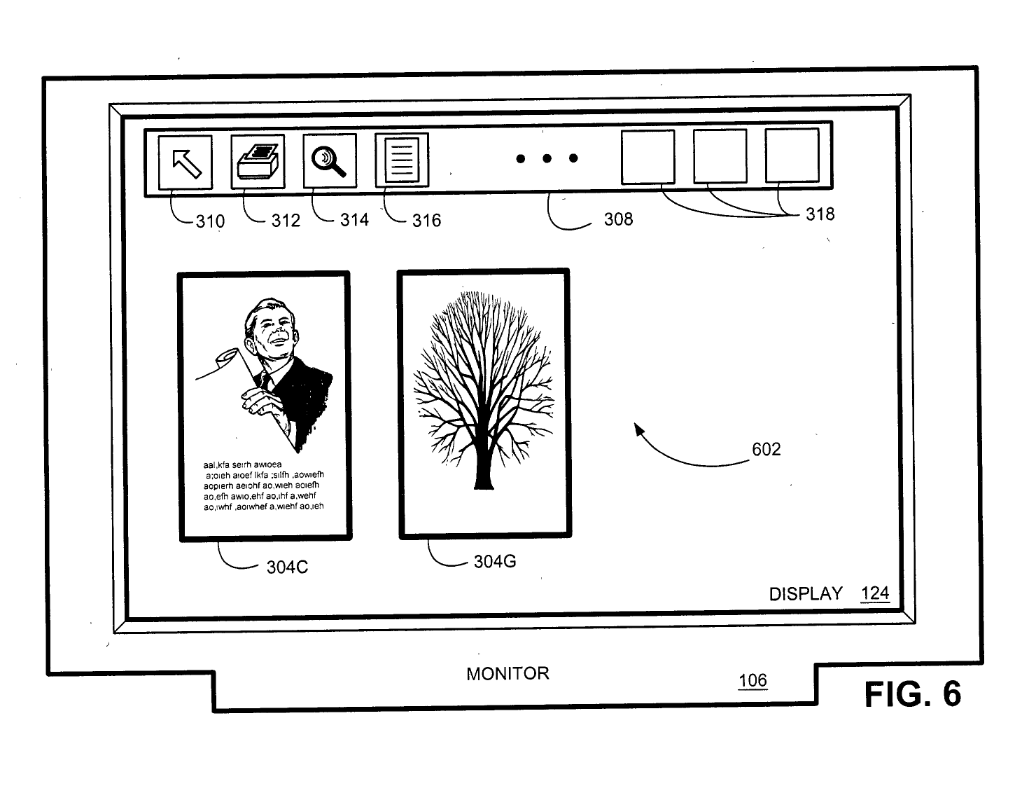

FIG. 6 is an illustration of a view 602 on a monitor 106 showing the enlargement of the thumbnail images 304C and 304G to be printed after selected thumbnail images 304A-B, 304D-F, and 304H (FIGS. 3 and 5) have been deselected by an embodiment of the present invention. With this embodiment, as thumbnail images are deselected and deleted from the view 602, remaining thumbnail images are enlarged as space becomes available on view 602. Thus, after thumbnail images 304A-B, 304D-F, and 304H are deleted from the view 602, the remaining thumbnail images 304C and 304G are enlarged to a convenient size.

Returning to FIG. 1, a generalized description of the operation of one embodiment of the present invention is now described. Prior to processing print pages with the present invention, a web page, e-mail or other image(s) is viewed on monitor 106 (for example, see FIG. 2). The user inputs an appropriate command to initialize the printing process, such that the processor 112 retrieves and executes the page print logic 122, via connection 130, of the present invention. A view of thumbnail images corresponding to print pages is displayed on display 124. That is, the present invention determines the print pages, generates thumbnail images corresponding to the print pages, and communicates the generated thumbnail images for display, via connections 132, 134 and display interface 118. When a second print command is generated by the user, indicating the conclusion of processing print pages with the present invention, print pages that are to be printed are communicated to a printing device (not shown), via connections 146 and 148 and printing device interface 126.

As described herein, the user may provide instructions to deselect thumbnail images (or select thumbnail images, depending upon the embodiment) that correspond to print pages that are not to be printed (or print pages that are to be printed, depending upon the embodiment) before the second print command is generated. Such instructions may be provided from keyboard 108 (via connections 136, 138 and input device interface 120), from mouse device 110 (via connections 136, 140 and input device interface 120), or from another suitable device configured to communicate user generated instructions to processor system 104. Thus, when the user provides a deselection instruction (or a selection instruction) via one of the above-described devices, a thumbnail image deselection signal (or a selection signal) is generated and communicated to the processor system 104.

As described herein, the current view may originate from locations accessed via the Internet or other suitable communication system, such as when a web page, e-mail or the like is displayed. Accordingly, the processor system 104 is understood to be coupled to an internet system (not shown) or other similar communication system. Thus, communication system interface 116 is illustrated for convenience as coupled to such a communication system via connections 142 and 144. Also, current views may be received from other sources, such as a memory (not shown).

For convenience, connections 134, 138, 140, 144 and 148 were illustrated as hardwire connections. Any one of the connections 134, 138, 140, 144 and/or 148 may be implemented with other suitable media, such as infrared, optical, wireless or the like without departing from the present invention. Furthermore, connections 130, 132, 136, 142 and 146 were illustrated for convenience as hard wire connections to processor 112. In other embodiments, one or more of these connections 130, 132, 136, 142 and/or 146 may be replaced with other suitable media, such as a bus or the like, and/or may be coupled via one or more other intermediary components (not shown) without departing from the present invention.

For convenience of describing the present invention, the present invention is described as residing in the PC system 102. Other embodiments may be equally employed in other types of devices. For example, the invention described herein may be implemented in a laptop or notebook type computer. Other embodiments may be implemented in a mainframe computer, in a distributed processor system, or in a work station environment. One embodiment is included as an integral component of the processing system, and another embodiment is implemented as an add-on feature to an existing processing system.

Furthermore, the components illustrated in FIG. 1 may be replaced by other suitable devices or may be optional. For example, display 124 may be replaced with any other suitable display device, such as a television, cathode ray tube (CRT), flat panel display, or the like, such that a user sees thumbnail images corresponding to print pages that are to be printed. Similarly, keyboard 108 may be replaced by another suitable interface device, or may even be optional in some embodiments, such that a user may initiate the printing process according to the present invention. Mouse device 110 may be replaced with a track ball device, a pointing stick device, a thumb ball device, a touch pad device, or the like, or even by selected keys on the keyboard 108, such that thumbnail images are selected by the present invention as described herein. In another embodiment, a touch sensitive display is employed such that the user selects (or deselects, depending upon the embodiment) thumbnail images by touching the area of the display where a thumbnail image is displayed. Accordingly, such above-described devices are configured to generate a thumbnail image selection signal, deselection signal and/or a reselection signal that is communicated to the processor system 104.

For convenience of describing the present invention, the simplified example of FIG. 3 indicates to the user that the illustrative web page of FIG. 2, when printed without the further processing by the present invention, would result in eight pages of printed print pages when the user initiated the print command. That is, eight pages of paper would be used when the user prints the web page without deselecting undesirable print pages (or selecting desirable print pages, depending upon the embodiment) using the present invention. The web page of FIG. 2 is illustrative, and that other web pages may have any number of print pages. Thus, other web pages may be comprised of other numbers of print pages. Similarly, an e-mail, a communication or an image may be comprised of a plurality of print pages, only some of which are desirable by the user. Accordingly, a current view on a display having any number of print pages may be previewed by the user, and undesirable print pages are deselected (or desirable print pages are selected, depending upon the embodiment) by the present invention.

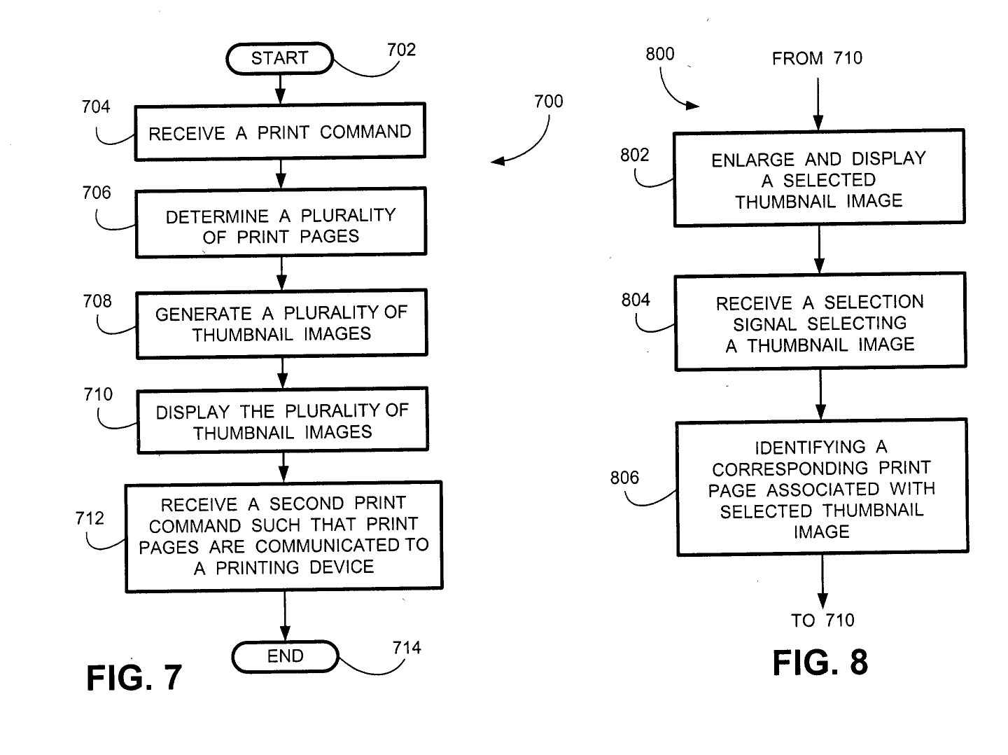

FIG. 7 is a flowchart 700 of a process for viewing print pages of a view using an embodiment of the present invention. The flow chart 700 shows the architecture, functionality, and operation of a possible implementation of the software for implementing the page print logic 122 (FIG. 1). In this regard, each block may represent a module, segment, or portion of code, which comprises one or more executable instructions for implementing the specified logical function(s). It should also be noted that in some alternative implementations, the functions noted in the blocks may occur out of the order noted in FIG. 7 or may include additional functions without departing significantly from the functionality of the page print logic 122. For example, two blocks shown in succession in FIG. 7 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process starts at block 702. At block 704 a print command is received. The print command is initiated by a user, indicating that the user desires to print the current view, such as, but not limited to, view 202 (FIG. 2) displayed on display 124. As described above, the current view may be of a web page, e-mail or other image(s). Accordingly, processor 112 (FIG. 1) retrieves and executes the page print logic 122 in response to receiving the initial print command.

At block 706 the page print logic 122 determines the plurality of print pages associated with the current view. At block 708 a plurality of thumbnail images are generated. Each one of the generated thumbnail images uniquely corresponds to a print page of a print file. Also, each one of the thumbnail images is a reduced view that is a representative image of its corresponding print page.

At block 710 the generated thumbnail images are communicated to a display. That is, the user previews the print pages that will be printed by a printing device by viewing the thumbnail images.

At block 712 a second print command is received such that print pages are communicated to the printing device without further processing by embodiments of the present invention. Accordingly, the print pages may then be printed by a print engine or the like controlling a printing device. In an alternative embodiment, a print engine code is incorporated into the page print logic 122. The process ends at block 714.

The above-described process of flow chart 700 generally describes embodiments the present invention as displaying thumbnail images corresponding to print pages of the current view such that a user may easily understand the general nature of the print pages. Upon receiving the second print command, the user is indicating that the user is accepting the print pages from printing without further processing by various embodiments of the present invention. However, in some situations, the user may not desire to print all of the print pages, or may desire to select specific print pages for printing. Accordingly, various embodiments provide a process for the user to discard undesirable print pages and/or select desirable print pages.

FIG. 8 is a flowchart 800 of a process for selecting print pages from a view using an embodiment of the present invention. The flow chart 800 shows the architecture, functionality, and operation of a possible implementation of various embodiments of the software for implementing the page print logic 122 (FIG. 1). In this regard, each block may represent a module, segment, or portion of code, which comprises one or more executable instructions for implementing the specified logical function(s). More particularly, the flow chart 800 is configured to be an enhancement to the above-described flow chart 700. It should also be noted that in some alternative implementations, the functions noted in the blocks may occur out of the order noted in FIGS. 7 and 8 or may include additional functions without departing significantly from the functionality of the page print logic 122.

The process starts at block 802 after the plurality of thumbnail images have been displayed (see block 710 of FIG. 7). At block 802 a thumbnail image is selected. An enlarged thumbnail image is generated and displayed to facilitate a more meaningful viewing of the thumbnail image content by the user. For example, the user may view an enlarged thumbnail image by positioning pointer icon 304 (FIG. 3) in close proximity to or over the thumbnail image of interest.

At block 804 at least one selection signal is received selecting at least one of the thumbnail images. At block 806, a corresponding print page associated with the selected thumbnail image is identified. The user may select any number of thumbnail images. The process then returns to block 710 such that the view is updated to indicate the user's selection of a thumbnail image. Accordingly, if the user desires to select another thumbnail image, the process proceeds again to block 802. This selection process is repeated as necessary so that the user selects as many thumbnail images as desired. When the user is finished selecting thumbnail images, the process proceeds to block 712 (FIG. 7).

In one embodiment, the above-described selection signal (also referred to herein for convenience as a deselection signal) selecting a thumbnail image indicates that the user does not want to print the print page associated with the selected thumbnail image. Accordingly, in the above-described embodiments where the user selects thumbnail images (also referred to herein for convenience as deselecting), the print page is not communicated to the printing device. Alternatively, in other embodiments, the selection signal selecting a thumbnail image indicates that the user does want to print the print page associated with the selected thumbnail image. Accordingly, in the above-described embodiments where the user selects thumbnail images, only the print pages corresponding to selected thumbnail images are communicated to the printing device.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for identifying print pages for printing, the method comprising the steps of:
receiving a print command;
determining a plurality of print pages associated with a current view on a display;
generating a plurality of thumbnail images, each one of the thumbnail images uniquely corresponding to one of the plurality of print pages and representing a reduced view of the corresponding print page;
communicating the plurality of thumbnail images to the display; and
receiving a second print command such that the print pages are communicated 11 to a printing device.

2. The method of claim 1, wherein each one of the thumbnail images representing its corresponding print page shows sufficient detail so that a user understands the general nature of the print page.

3. The method of claim 1, further comprising the steps of:
receiving at least one selection signal selecting at least one of the plurality of thumbnail images; and
identifying the corresponding print page associated with each selected thumbnail image such that the corresponding print page is not communicated when the second print command is received.

4. The method of claim 3, further comprising the step of deleting the selected thumbnail image from the view on the display.

5. The method of claim 4, further comprising the step of reordering the remaining thumbnail images on the view on the display.

6. The method of claim 3, further comprising the step of identifying the selected thumbnail image such that a user understands that the selected thumbnail image has been selected and that the associated print page will not be communicated to the printing device.

7. The method of claim 6, further comprising the steps of:
receiving at least one reselection signal reselecting one of the selected thumbnail images; and
identifying the corresponding print page associated with the reselected thumbnail image such that the corresponding print page is communicated when the second print command is received.

8. The method of claim 3, further comprising the steps of:
receiving at least one reselection signal reselecting one of the selected thumbnail images; and
identifying the corresponding print page associated with the reselected thumbnail image such that the corresponding print page is communicated when the second print command is received.

9. The method of claim 1, further comprising the steps of:
receiving at least one selection signal selecting at least one of the plurality of thumbnail images; and
identifying the corresponding print page associated with the selected thumbnail image such that only the corresponding print page is communicated when the second print command is received.

10. The method of claim 9, further comprising the step of generating a verify view, the verify view having thumbnail images corresponding to print pages communicated when the second print command is received.

11. The method of claim 9, further comprising the steps of:
generating at least one enlarged thumbnail image; and
displaying the enlarged thumbnail image on the display.

12. The method of claim 9, further comprising the step of identifying the selected thumbnail image such that a user understands that the selected thumbnail image has been selected and that the associated print page will be communicated to the printing device.

13. The method of claim 9, further comprising the steps of:
receiving at least one reselection signal reselecting one of the selected thumbnail images; and
identifying the corresponding print page associated with the reselected thumbnail image such that the corresponding print page is not communicated when the second print command is received.

14. The method of claim 1, further comprising the step of generating an enlarged view of a thumbnail image.

15. A system that identifies print pages for printing, comprising:
an input device configured to generate and communicate an initial print command and a second print command;
a processor configured to determine a plurality of print pages associated with a displayed view in response to receiving the initial print command, and further configured to generate a plurality of thumbnail images, each one of the thumbnail images uniquely corresponding to one of the plurality of print pages and representing a reduced view of its corresponding print page;
a display interface configured to communicate the plurality of thumbnail images to a display; and
a printing device interface configured to communicate the print pages to a printing device for printing when the second print command is received.

16. The system of claim 15, wherein the input device is further configured to generate a selection signal identifying a selected one of the plurality of thumbnail images such that a corresponding print page is not communicated to the printing device when the second print command is received.

17. The system of claim 15, wherein the input device is further configured to generate a selection signal identifying a selected one of the plurality of thumbnail images such that only a corresponding print page is communicated to the printing device when the second print command is received.

18. A system for identifying print pages for printing, comprising:
means for receiving a print command;
means for determining a plurality of print pages associated with a current view on a display;
means for generating a plurality of thumbnail images, each one of the thumbnail images uniquely corresponding to one of the plurality of print pages and representing a reduced view of the corresponding print page;
means for receiving at least one selection signal selecting one of the plurality of thumbnail images;
means for identifying the corresponding print page associated with each selected thumbnail image such that the corresponding print page is not communicated when a second print command is received; and
means for receiving the second print command such that remaining print pages are communicated to a printing device.

19. A system for identifying print pages for printing, comprising:
means for receiving a print command;
means for determining a plurality of print pages associated with a current view on a display;
means for generating a plurality of thumbnail images, each one of the thumbnail images uniquely corresponding to one of the plurality of print pages and representing a reduced view of the corresponding print page;
means for receiving at least one selection signal selecting one of the plurality of thumbnail images;
means for identifying the corresponding print page associated with each selected thumbnail image such that the corresponding print page is communicated when a second print command is received; and
means for receiving the second print command such that the print pages corresponding to the selected thumbnail images are communicated to a printing device.

20. A computer-readable medium having a program for identifying print pages for printing, the program comprising logic configured to perform the steps of:
receiving a print command;
determining a plurality of print pages associated with a current view on a display;
generating a plurality of thumbnail images, each one of the thumbnail images uniquely corresponding to one of the plurality of print pages and representing a reduced view of the corresponding print page; and
receiving a second print command such that the print pages are communicated to a printing device for printing.

21. The computer-readable medium of claim 20, further comprising logic configured to perform the steps of:
receiving at least one selection signal selecting at least one of the plurality of thumbnail images; and
identifying the corresponding print page associated with the selected thumbnail image such that the corresponding print page is not communicated when the second print command is received.

22. The computer-readable medium of claim 20, further comprising logic configured to perform the steps of:
receiving at least one selection signal selecting at least one of the plurality of thumbnail images; and
identifying the corresponding print page associated with the selected thumbnail image such that only the corresponding print page is communicated when the second print command is received.
